(19) United States
(12) Patent Application Publication
(10) Pub. No.: US 2011/0179434 A1
(43) Pub. Date: Jul. 21, 2011

(54) SELECTION AND PERSONALISATION SYSTEM FOR MEDIA

(76) Inventor: Thomas JÖRG, Zurich (CH)

(21) Appl. No.: 12/950,976

(22) Filed: Nov. 19, 2010

Related U.S. Application Data
(63) Continuation-in-part of application No. 12/992,454.
(60) Provisional application No. 61/127,766, filed on May 14, 2008.

(30) Foreign Application Priority Data
May 14, 2008 (EP) 08075497.1

(51) Int. Cl. H04N 7/10; H04N 7/16

(52) U.S. Cl. 725/1; 725/32

(57) ABSTRACT

Disclosed is a method and system through which films can be discovered and film packages that are tailored to the individual can be put together and purchased.

### CROSS-REFERENCE TO RELATED APPLICATIONS

This application is a continuation in part application of U.S. patent application Ser. No. 12/992,454, filed Nov. 12, 2010, which is incorporated herein by reference in its entirety and which is the U.S. national stage of international patent application PCT/EP2009/003690, filed May 14, 2009, which claims priority to European patent application EP 08075497.1, filed May 14, 2008 and also claims the benefit of U.S. provisional application No. 61/127,766, filed May 14, 2008.

### BACKGROUND OF THE INVENTION

When films are not screened in the cinema, film programs are played sequentially on separate channels. In addition to channels which are disseminated in analog format, a growing number of programs are being broadcast digitally. Individual providers have started to disseminate digital TV signals via internet protocols across the World Wide Web. This “zapping” over a number of channels is widespread. The user switches between the available channels until he finds a program that he likes and watches.

“Viewer quotas” are surveyed using complex statistical systems based solely on individual random samples and extrapolations. Measuring devices are installed among a group of reference viewers which are selected on the basis of demographic models and their TV consumption is analysed. The data obtained are extrapolated to the entire population.

Many trailers and film excerpts for programs can be retrieved on the internet. Films are arranged into galleries by categories. They are shown in windows on websites. Complete films can also be purchased or rented. In this case “Digital-Rights-Management” systems (DRM) are used making the purchased film file accessible for only a certain period or a certain hardware device. Information about the rights can only be read with technical modules (software or hardware). DRM systems operate on a technical level that is not comprehensible for humans.

Free film licenses (so-called non-major films) are traded in national and international markets. Licenses for various types of utilization are granted in various territories. For example, for Japan, the right for the theatrical, TV and DVD version of the respective Japanese language version lasts for five years. Generally the licensee is obliged to settle his revenues and expenditures with the licensor. In practice it is very difficult to check this settlement of accounts. It is impossible for a German licensor to reconstruct how many DVDs really are sold across the shop counter in Japan. That is why revenue guarantees (known as minimum guarantees or MGs) play a vital role in the market. Based on empirical values in his market, the licensor guarantees minimum sales levels and must pay the corresponding licensor component (licence fee) immediately upon conclusion of the contract. Money is earned primarily in the TV and DVD segment and the market participants do not expect to earn much at the cinema box office. The advertising costs there (known as P&A—Press & Advertising) are simply too high. An increasing number of films are being produced worldwide, while the competition for the declining viewer interest in the cinema has become intense. Nonetheless, films are still screened in cinemas. The market participants do this primarily in view of the planned distribution on DVD; the cinema is currently a key advertising machine for DVD sales.

In the blogging segment the categorizing of content on the basis of key words (“tagging”) is widespread. For example, various tags are allocated to a blog entry. The tags are grouped in “Tag Clouds”. If a tag is clicked, the associated entries are displayed. It is only possible to select one tag.

The public is being increasingly overwhelmed by the infinite variety of offerings. In addition to the hundreds of channels accessible via cable and satellite, customers are bombarded with millions of programs disseminated via the internet. Viewers quickly not only lose the overview considering this relentless diversity of offerings, but also the desire to watch exciting content. For a long time now there has not been any genuine community feeling (“prime time hit” on TV). Sociologists speak of the “atomizing of society”. At the same time, ever more people are appreciating the internet as a two-way medium. Forums and social networks of a wide variety of types have developed. People communicate with each other and discuss content matter. Above all the “blogosphere” is growing at immense speed. Blogs are personal online diaries. With a sophisticated address system, bloggers can refer in the articles they publish themselves to other contents already published elsewhere. In the area of online film sales, however, this discussion area is largely separated from the online shops.

The existing systems are built on a proprietary basis and try, as far as possible, to build up barriers against discussion forums.

In the internet arena there is no simple access to motion picture content which is based on discovery. Zapping as known from the TV sector cannot be transferred to the internet. The access to films via links is laborious and not intuitive. First a link text has to be interpreted or a cover picture viewed. Then it is necessary to make a decision—I want to watch this film now. Film discoveries are only possible via text and image.

In the IPTV or TV segment it is possible to refer to individual channels, but not to individual contents or dynamically created compilations.

The categorization of films according to genres that is widespread in online shops does not pay justice to the film contents, ambitions and statements of the filmmakers. Films are only allocated to one category. A film is then a drama or a thriller or a classic. The idea originates from the time of real-life video stores where a film can physically stand on only one shelf. However, especially in the case of high-value narrating strategies and well-developed dramaturgies, allocation to a category is arbitrary and, in certain cases, extremely difficult. The film “American Beauty” is a drama, a love-story, a coming of age film, a social drama, a thriller, an epic, a melodrama and a tragedy all at the same time!

The established DRM systems are not compatible with each other. A film file encoded with the very widespread WINDOW-Media-DRM cannot be played on hardware such as APPLE's IPOD or IPHONE. A film acquired in ITUNES does not work on Microsoft's game console XBOX or SONY's PLAYSTATION. Operating systems such as LINUS are not supported. Customers know that in view of the technical incompatibilities they will only encounter problems when shopping online and they are correct in being reserved. When in doubt they buy a DVD, or download one illegally. The customer cannot read the information on rights hidden in film files.

Although economic theories state that markets can only function well when they are transparent and the costs of transactions are low, the film license markets are characterised by lack of transparency. Admittedly, market data are published in the theatrical segment (in Europe these are more likely to be attendance figures, in the USA exclusively “Box Office” results), but in the considerably more important DVD sector the sales figures are kept secret by the distribution firms. Only the delivery figures are published. The lack of transparency is exaggerated by the fact that accounts are not settled promptly. US Majors settle accounts weekly, but monthly settlements are the norm. Library titles are settled half-yearly or even yearly. Different systems and method, such as those disclosed in U.S. Patent Publication 20060230427, U.S. Patent Publication 20060271594, U.S. Patent Publication 20070220575 and U.S. Patent Publication 20070219985, which are incorporated herein by reference in their entirety, seek to provide more individualized methods and systems for media selection.

However, there remains a need in the art to provide a system and method, which address and/or improves one or more of the above referenced deficiencies and/or drawbacks.

### SUMMARY OF THE INVENTION

In certain aspects, the present invention addresses and/improves the above outlined and/or other deficiencies and/or drawbacks of prior art methods and systems.

Generally, the present invention is directed at methods and systems for the selection and/or distribution of media. The methods and systems allow for the selection and preferably purchase by a participant and/or viewer via media information which comprises (a) a playful and/or (b) systematic access. Media include, but are not limited to, visual, auditory and/or audiovisual media such as, but not limited to, films, books, music, audio plays, audio books, virtual exhibitions and/or games. In certain embodiments, the media originate from different sources such as different proprietors, in particular the proprietors of the exploitation rights or their representatives. A system according to the invention may comprise as components: a central database, a live encoding system, a raw memory, a media memory, a content-delivery system, a payment system and/or a billing and reporting system. The systems and/or methods of the present invention may use any one of these system components to execute or support one or more of the steps and/or functions discussed herein, including, but not limited to, encoding, providing, determining, preparing, inserting, transmitting and/or storing media and/or information, such as, but not limited to, a main film, data about the size of the film, its dimension, the film format, its data rate, certain images, particulars of the customer, metadata such as titles, content, summaries, cast and crew lists, vitae, technical data, awards, contact data, production and/or distribution firms, festivals, promoters as well as trailers, billing information/data, payment information/data, reporting information/data, proprietor information/data (and/or data of their representatives), licence information/data, cooperation information/data etc. The most common interface of the present invention is a computer screen. This interface can provide systematic access or playful access to the content.

The invention is also directed at a media selection and distribution system and/or method offering a large number of visual auditory and/or audiovisual media of a number of different exploitation right proprietors or their representatives for selection and purchase by a participant/viewer via media information, comprising (a) a playful and/or (b) systematic access,

wherein a central database, a live encoding system, a raw memory, a media memory, a content-delivery system, a payment system and a billing and reporting system are provided and wherein a film is personalised by:
encoding of a main film including metadata,
provision of a pre-encoded main film,
determining parameters of the pre-encoded main film,
preparing trailers by providing individual images having specific dimensions of the main film,
inserting, as clearly visible title, personal particulars of a customer and an electronic signature of a publisher into the individual images,
encoding of the personalised and signed individual images as film with parameters, wherein the parameters are exactly the same parameters as those of the main film, and
inserting trailers into the main film, and
transmission of the individual film to the customer.

The system and/or method might further contain functions for/allow for (i) selection, (ii) payment and (iii) prompt reporting including (iv) billing.

The invention is also directed at a method for offering a large number of visual auditory and/or audiovisual media comprising
encoding and condensing on a content-delivery-system accessible by one or more processors a main film including metadata via a live encoding system so that a pre-encoded main film including metadata is provided,
computer-aided determination of parameters of the pre-encoded main film including size, dimensions, format and data rate,
wherein a computer-aided or manual extracted excerpt of the pre-encoded main film with the dimensions of the main film, or an available trailer of the main film is provided,
displaying the excerpt or the trailer to a potential customer on a projection screen, preferably a computer screen,
computer-aided insertion, as a clearly visible title, of personal particulars of the customer and an electronic signature of the publisher of the pre-encoded main film into the individual images of the excerpt or the trailer to produce personalized and signed image(s),
computer-aided encoding of the personalised and signed individual image(s) with parameters, wherein the parameters are exactly the same parameters as those of the pre-encoded main film, so that the images display specifications which are exactly those of the pre-encoded main film,
computer-aided insertion of the personalised and signed individual images into the pre-encoded main film, by combining video data of the personalised and signed individual image(s) and the pre-encoded main film, and
remote data transmission of the film to the customer, wherein the customer accesses the film via a projection screen, preferably a computer screen, wherein the media are provided by different exploitation right proprietors or their representatives.

The invention is also directed at a media selection and distribution system offering a large number of visual auditory and/or audiovisual media of a number of different exploitation right proprietors or their representatives, comprising:
one or more processor readable media that are accessible by one or more processors;
one or more communication devices operatively coupled to the one or more processors;
at least one database stored on the one or more processor readable media, the at least one database comprising:
   a pre-encoded main film including metadata,
   parameters of the pre-encoded main film including size, dimensions, format and data rate,
   trailers in form of individual images with specific dimensions of the main film,
wherein the one or more processors are programmed and configured to:
   insert personal particulars of a customer and a electronic signature of the publisher into the individual images created as clearly visible title to create personalized and signed individual images,
   encode the personalised and signed individual images as film with exactly the same parameters as the main film,
   insert the trailers into the main film and
   transmit the individual film to the customer, wherein the customer accesses the film via (a) a playful interface or (b) a systematic interface and wherein the media are provided by different exploitation right proprietors or their representatives.

According to the invention, a medium may be delivered on basis of an existing licence or cooperation agreement between the proprietor of the exploitation rights or his representative and a system operator. The medium may be filed in the raw memory. Media excerpts may be selected and both excerpt and the entire medium may be encoded in the encoding system as internet-compatible files and filed in the media memory. Metadata, for example title, contents, summaries, cast and crew lists, preferably including vitae, technical data, awards and contact data may be updated/fed into the central database and a consumer price may be fixed. The consumer price may be determined based on statistical data.

In accordance with (a) three functions may be offered when presenting the medium excerpt, e.g., on a computer screen:
“next medium”, which triggers the next media excerpt,
“more” which visualises the metadata including the consumer price, and/or
“reserve”, which adds the medium to a wish list.
   The activation of the three functions may be analysed and prompt triggering of the “next medium” function may save the medium as an uninteresting medium. Excerpts that are essentially viewed completely and purchased may be saved as interesting. A group of several viewers and/or several purchasers (or purchases) may help a medium to obtain better positioning in a trailer show. The functions “next medium” and “reserve” can, in certain embodiments, be selected any number of times.

In accordance with (b) an overview of the media offered by the proprietors of the exploitation rights or their representatives may be transmitted to, e.g., a computer screen of a viewer and the selection of the media may appear on the screen associated with keywords. When the keywords are activated/clicked, media, which are not allocated to said keywords, may be deleted from the selection. The viewer can activate/click several keywords, which results in the number of media offered being continuously reduced. The list of keywords may be updated with each click/activation, preferably in a way that only those keywords appear on the computer screen that can be allocated to the media in a reduced number.

The invention is also directed at a system and/or method, which may include any one or all of the features of the above mentioned systems and/or methods and that offers a large number of visual, auditory and/or audiovisual media, in particular films, TV broadcasts, series, books, pieces of music, audio plays, audio books, virtual exhibitions or games of a number of different proprietors of exploitation rights or their representatives for selection and purchase and/or rent by a participant/viewer via media information comprising (a) a playful and/or (b) systematic access, wherein

a raw memory, an encoding system, a database, a media memory, a content delivery system, a payment system and a live encoding system with title generator are provided, wherein
the medium is delivered based on an existing licence or cooperation arrangement between the proprietor of the exploitation rights or his representative and the system operator,
the medium is filed in the raw memory in digital quality and wherein analog media are digitised if appropriate,
a medium excerpt is selected and both the excerpt and the entire medium are encoded in the encoding system as internet-compatible files and kept available in the media memory,
metadata, for example title, contents, summaries, cast and crew lists, production and distribution firms, festivals, promoters and financiers etc., preferably including vitae, technical data, awards and contact data are updated into the central database and a consumer price is fixed,
an address is created, wherein the address http://limiting_keywords.systemame.topleveldomain/ leads to display of an optimised preview program, and wherein with http://limiting_keywords.systemname.topleveldomain/preview+media-title a channel with the selected medium can be started,
and wherein with http://limiting_keywords.systemame.topleveldomain/ media-title the metadata including the consumer price are visualised,
according to (a) presentation of the medium excerpt on the computer screen, wherein three functions are offered:
   “next medium”, which triggers the next media excerpt,
   “more”, which visualises the metadata including the consumer price, and/or
   “reserve”, which adds the medium to a wish list,
wherein activation of the three functions is analysed and wherein prompt triggering of the “next medium” function saves the medium as an uninteresting medium, and excerpts that are essentially viewed completely and purchased are saved as interesting, wherein a group of several purchases helps a medium to obtain better positioning in a trailer show and wherein the functions “next medium” and “reserve” can be selected any number of times,
the viewer transmits an intention to purchase one or more media,
the central database transmits an already communicated consumer price to the payment system,
payment information, a name and address of the viewer are transmitted to the payment system, which verifies payment and reports the verification to the distribution system,
the name and/or email address of the viewer is transmitted to the encoding system,
the complete medium is retrieved from the media memory to the encoding system, wherein the medium is personalised by the said name and/or email address, with the personalising taking place in a manner legible for humans, in particular by displaying the purchaser's name and email address as a title in the image, and the personalised medium is delivered via the content-delivery network and the resulting transmission costs are reported to the database, or
according to (b) an overview of the media offered by the proprietors of the exploitation rights or their representatives is transmitted to a viewer's computer screen, wherein a selection of media appears on the screen associated with keywords,
wherein when the keywords are activated/clicked media, which are not allocated to said keywords, are deleted from the selection, wherein the viewer can activate/click several keywords, which results in the number of media offered being continuously reduced and wherein, at the same time, the list of keywords is updated with each click/activation in such a way that only those keywords appear on the computer screen that can be allocated to the media in a reduced number,
if appropriate, repetition of this operation until the number of media offered is reduced to one medium.
   The parameters of the pre-encoded main film may be size, dimensions, format and/or data rate.

### BRIEF DESCRIPTION OF THE DRAWING

FIG. 1 shows an example of how one of the system/methods described herein functions.

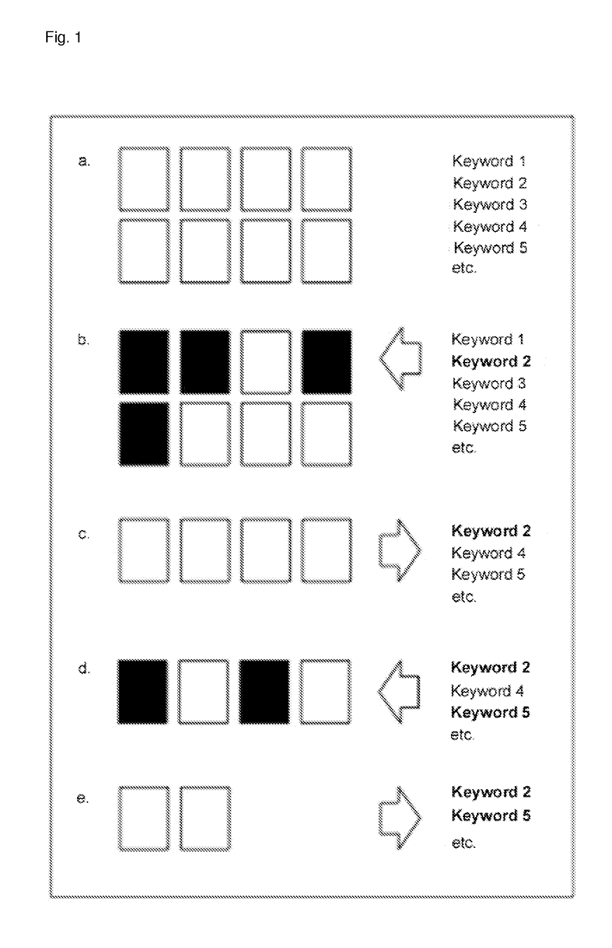

### DESCRIPTION OF VARIOUS AND PREFERRED EMBODIMENTS OF THE INVENTION

The present system allows compilation, purchase and delivery of personalised film tiles or film packages for the client. A visual DRM guarantees at the same time security for the licensor and technical compatibility for the customer (licensee).

It was completely surprising that the task can be solved by the media selection and distribution system of the invention. A large number of visual, auditory and/or audio-visual media, comprising films, books, pieces of music, audio plays, audio books, virtual exhibitions or games from several owners of exploitation rights or their representatives are offered for selection and purchase by a participant/viewer via media information. The offer can be made via an access comprising (a) a playful and/or (b) a systematic access. The system comprises a central database, a live encoding system, a raw memory, a media memory, a content-delivery system, a payment system and a billing and reporting system. The system of the invention allows a film to be personalised easily and quickly. The film (main film) is encoded including metadata. Alter this, a pre-encoded main film is made available, wherein parameters, essentially size, dimension, format or data rate are being determined. This characterises the film and makes it clearly determinable. Trailers are then prepared in which individual images, having the specific dimensions of the main film, are provided. The film is personalised by inserting the personal data of a customer and the signature of the publisher, as a readily visible title, into the individual images generated. This allows clear allocation of the film and makes its identification quick and easy.

After this, the personalised and signed individual images are encoded as film, using the exact parameters of the main film. When the trailers have also been integrated into the main film, the film—the individualised film—is transmitted to the customer. This personalisation communicates to the customer that he has purchased a special product uniquely tailored for him. The system according to the invention thus permits fast and easy labelling of a film, using the personal data of the customer. Surprisingly, this represents considerable technical progress, since it allows digital media, which due to the internet, are quickly exchanged and distributed, are given personal label, which preferably permits tracking. This also surprisingly allows film sales to be automated in a way that allows faster and more efficient sales of digital media than the systems described in the state of the art, wherein, despite the automation process, the individual—the customer—is not neglected, but rather receives an individual product. This further leads to the customer identifying with the product purchased and being satisfied with the purchase. In addition, the system according to the invention offers advantages for the retail and wholesale industry, since the personalisation of the films reduces illegal distribution.

The media selection and distribution system preferably comprises not only personalisation of the film, but also (i) selection, (ii) payment and (iii) prompt reporting, including (iv) settlement of accounts. The customer or prospective buyer is offered products via a simply structured menu, and can look at these for a short time or watch a trailer. After the customer has selected an item, the selection is confirmed via a high-speed system and the customer is informed of the amount to be paid, wherein the customer can still decide against buying the product. The customer's interest in a particular product is reported promptly and the information is forwarded to the system. If a new customer is involved, he registers by entering his personal data, wherein the personal data is required for the subsequent settlement of accounts. The data can be stored in the system based on the latest encoding techniques, so that further sales, if applicable, can be processed faster and be made easier for the customer. The amount to be paid is then displayed to the customer in a clearly arranged report, and, if appropriate, an electronic copy of the receipt is delivered to the customer. The preferred embodiment surprisingly ensures effective data processing and fast routing, so that internet transactions proceed optimally for buyer and seller and are structured cost-efficiently.

It is further preferred that the system comprises the following steps: based on an existing license or cooperation agreement between the proprietor of the exploitation rights or his representative and a system operator, the medium is delivered. The medium is, for the sake of simplicity, filed in the raw memory. Media excerpts are selected and both excerpts as well as the entire medium are encoded in the encoding system as internet-compatible files and filed in the media memory. Metadata, for example title, contents, plot summaries, cast and crew lists, preferably including vitae, technical data, awards and contact data are fed into the central database and a consumer price is fixed, wherein the consumer price is determined based of statistical data collected. The customer is, according to (a), offered three functions during the presentation of the media excerpt on the computer screen:
“next medium”, which triggers the next media excerpt,
“more”, which visualises the metadata including the consumer price, and/or
“reserve”, which adds the medium to a wish list.
   An analysis of the activation of the three functions is performed, wherein a fast triggering of the function “next medium” leads to storage as an uninteresting medium. When excerpts are essentially viewed completely and purchased, they are stored as interesting and a group of several viewers and/or several sales helps a medium to a better positioning in a trailer show. The functions “next medium” and “reserve” can be selected any number of times. The intention of the viewer—the potential customer—to buy is transmitted to the system and the central database transmits the already communicated consumer price to the payment system. The preferred embodiment surprisingly allows fast and effective automation of a purchase transaction, wherein the customer's interests is being taken into account when assembling the offering. The customer is not rendered anonymous on the internet, thus achieving a higher satisfaction of the customer, as his individual wishes can be taken into account. Moreover the preferred embodiment is surprisingly reliable and flexible and offers various options to the customer at each step, whereby the customer very quickly finds himself in a selection of media suggested by the system and tailored specifically to his wishes. The preferred embodiment thus substantially improves customer-friendliness.

In a further preferred embodiment, a system is used that, according to (b), transmits an overview of the media offered by the proprietors of exploitation rights or their representatives to a computer screen of a viewer, wherein the selection of the media is, associated with keywords, displayed on the screen. All the relevant information is thus presented simply and clearly to the customer. The customer activates or clicks keywords, wherein any media that cannot be associated with these keywords are deleted from the selection and wherein the viewer can, each time, activate/click several keywords. This continuously reduces the number of media offered and at the same time updates the list of keywords with each click/activation, so that only those keywords that can be associated with the media in reduced number appear on the computer screen. The preferred application surprisingly represents technical progress, as the customer or prospective buyer is not confronted with unnecessary information, but instead is shown a selection that is corresponds to his interests.

This allows the customer a fast, simple, effective and low-cost search. Furthermore, it is suggested to the customer that his needs are being taken into account, which results in higher satisfaction.

The invention also relates in particular in a preferred embodiment to a system that offers a variety of visual, auditory and/or audio-visual media, in particular films, TV broadcasts, series, books, pieces of music, audio plays, audio books, virtual exhibitions or games of several proprietors of exploitation rights or their representatives for selection and purchase and/or rental by a participant/viewer via media information comprising (a) playful and/or (b) systematic access. The system contains a raw memory, an encoding system, a database, a media memory, a content-delivery system, a payment system and a live encoding system with title generator, wherein
the medium is delivered based on an existing license or cooperation contract between the proprietor of the exploitation rights or his representative and the system operator
the medium is filed in digital quality—analog media are also digitised—in the raw memory
a media excerpt is selected and both excerpt and the entire medium are encoded in the encoding system as internet-compatible files and kept ready in the media memory
metadata, for example title, contents, summaries, cast and crew lists, production and distribution firms, festivals, promoters and financiers etc., preferably including vitae, technical particulars, awards and contact data fed into the central database and a consumer price is fixed,
addressing is performed, wherein the address
   http://limiting_keywords.systemname.topleveldomain/leads to the display of the optimised preview program, and with
   http://limiting_keywords.systemname.topleveldomain/preview+mediatitle a channel with the selected medium can start, and with
   http://limiting_keywords.systemname.topleveldomain/mediatitle the metadata including the consumer price is visualised.
according to (a) the media excerpt is presented on the computer screen, wherein three functions are offered:
   “next medium”, which triggers the next media excerpt.
   “more”, which visualises the metadata including the consumer price, and/or
   “reserve”, which adds the medium to a wish list.
An analysis of the activation of the three functions is performed, wherein a fast triggering of the function “next medium” leads to storage as an uninteresting medium. When excerpts are essentially viewed completely and purchased, they are stored as interesting and a group of several sales helps a medium to a better positioning in a trailer show. The functions “next medium” and “reserve” can be selected any number of times
Transmission of an intention to buy one or more media by the viewer
Transmission of the already communicated consumer price by the central database to the payment system
Disclosure of the payment information, the name and address of the viewer to the payment system and verification of the payment by the payment system and reporting of the verification by the payment system to the distribution system
Transmission of the name and/or email address of the viewer to the encoding system
Retrieving the complete medium from the media memory to the encoding system, wherein the medium is personalised via the said name and/or e-mail address, wherein the personalisation is carried out in a manner legible for humans, in particular by displaying the name and e-mail address of the buyer as title in the image, and wherein the personalised medium is delivered via the content-delivery network and the resulting transmission costs are reported to the database, or
according to b) a transmission of an overview of the media offered by the proprietor of the exploitation rights or their representatives is displayed on a computer screen of a viewer, wherein the selection of the media appears on the screen associated with keywords
Activation/clicking of keywords, wherein the media not associated with these keywords are deleted from the selection, wherein the viewer can activate/click several keywords each time, as a result of which the number of media offered is continuously reduced and at the same time the list of keywords is updated with each click/activation in such a way that only those keywords appear on the computer screen that can be associated with the media in a reduced number
where applicable, repetition of this operation until the quantity of media offered is reduced to one medium.
   Surprisingly, the system allows fast and effective personalisation of a digital medium and thus represents technical progress. Such labelling can also be used to track illegal copies.

### 1. Preparations

### 1.1. License Agreement and Delivery

Alter concluding a license agreement with the operator of the system described, the licensor delivers a film to the encoding station. This can be a 35 mm copy, a video tape or a digital data carrier.

### 1.2. Equipment and Encoding

The film data delivered are, if necessary, digitised and initially filed unchanged in a memory system. Metadata such as film title, contents, summaries, cast and crew lists, film posters, sub-titles etc. are fed into a central database. The information supplied by the licensor is processed into a consistent and uniform form and translated into various languages. An excerpt representative for the film is selected. If a trailer is available, this trailer is processed as well. A price is determined for each version and for each territory in which the film can be sold. New films are selected for promotion every day.

### 1.3. Encoding

During the encoding, the films are encoded and condensed (pre-encoding) in internet-compatible files in accordance with the currently prevailing standards and kept ready for retrieval in a further memory system (Content-Delivery-Network).

### 2. User Story

### 2.1 .A Selection of a Suitable Film via Preview Zapping

Input:

The customer enters an address into the address line of his browser or clicks on a link of an external website referring to the system. The customer's IP-address is reported to the selection system. Technical procedure:

The system selects the films to be promoted on this day from the central database. The location (territory) of the customer is determined via the IP-address. Only films that the customer can purchase in his territory are advertised or sold to the customer. The respective film excerpts are called up from the content-delivery system and played in the video player loaded up in the customer's browser.

Output:

A full-screen excerpt is shown to the customer. He can click on three functions (FIG. 2):
Next film: with this function the next film excerpt or trailer is triggered
Film info: with this function a site on which more about the film can be learned is triggered.
Remember: with this function the film is added to a wish list
   “Next film” and “remember” can be clicked any number of times. The clicks on these three functions are analysed. Film excerpts that are often clicked away with the key “next film” are no longer offered as often. Film excerpts that are frequently remembered and subsequently purchased are played more frequently. As a result, the program of the promotion interface is continuously optimized via the system. Fast clicking away is interpreted as “this film is not interesting”. Excerpts that are frequently viewed through to the end are identified as interesting. The statistical evaluation of the ratio trailer presentation/purchase is also incorporated into the assessment. Trailers that frequently lead to a purchase when they are shown are identified as interesting. Trailers that rarely lead to a purchase when they are shown are not interesting. This optimisation is based on the direct user feedback from the viewer community. The emphasis is on the community of viewers, which helps a good film to obtain a better placing in the trailer show and thus, effectively, recommends it as a group to other users. An editorial team mixes new releases and promotions into this purely success-oriented chart system.

Effect:

As a result, the customer can click through the films offered to him in very simple manner. Based on the film excerpt he can decide whether or not he likes the film. Studies have shown that a customer, after watching the excerpt for a few seconds, can say, if he wants to follow the film further or not. With many clicks and many customers, the promotion area is. in addition, automatically constantly optimised.

### 2.1 .B Selection of a Suitable Film Via an Overview System/Tagging

Alternative to zapping via “next film”, the customer can access a clear, systematically structured promotion interface. Here the user is first confronted with an overview of all the films on offer. This selection system functions not only with films, but also with all kinds of objects. For example also with items of furniture, automobiles, foods, beverages, persons (e.g. actors or the like).

Input:

The customer can reduce the number of films via a sophisticated system which is based on keyword allocations:
a. A number of keywords are allocated to each symbol. A symbol represents an object. In this case a film. The number of keywords is unlimited. A balanced relation between frequently used and rare keywords is maintained. Initially all the symbols can be seen in an overview area. All the keywords are specified in a list. This list of keywords can be structured via categories. They are arranged according to the number of allocations relative to the current quantity of symbols.
b. Touching a keyword with the cursor highlights all the symbols labelled with the keyword.
c. Clicking on the keyword reduces the number of symbols: Only those symbols can now be seen that are allocated to the clicked keyword can. At the same time the list of keywords is updated: only those keywords that are allocated to the current (reduced) quantity can be seen.
   This procedure can be repeated frequently until the quantity is reduced to one symbol. Any number of keywords can be selected to reduce the number of symbols. Symbols already selected can be de-selected at any time. The respective updating of the keyword list displayed guarantees that only keywords related to the current batch of symbols are visible.

This system exists both for films and for the filmmakers allocated to the films.

### 2.2. Payment

After the user has announced his intention to buy, the central database transmits the price of the film or the film package to an (external or internal) payment system. It is also possible to maintain a credit balance on the selection system. In this case the purchase goes particularly fast. During the interaction with the payment system the given name and family name of the customer are recorded (personal particulars).

### 2.3. Personalising of the Film File

The neutral film is personalised in the injecting system. More specifically, in this process a title identifying the buyer of the film is inserted info the film at the beginning of the film. Since the customer should not have to wait long for the film file to be made available after the payment process has been completed, only a few seconds are available for this personalising. The encoding of a film can, using conventional methods, take more than twice the time of the length of a film. So that the customer does not have to wait for hours, the main film has already been ready pre-encoded (see 1.3). In the injection system, only the short film clip in which the personal data of the customer can be seen, is now encoded (trailer). The clip is then inserted into the pre-encoded main film. Thus, it is not necessary to re-encode the entire film: A great deal of time is saved. For this to function, the short newly created personalised trailer must have exactly the same specifications as the pre-encoded main film itself.

Input:

The personal data of the customer (e.g. given name and family name) are reported to the injecting system together with a reference to the film which has to be personalised. Several injecting systems may be available to optimise the system performance. The workload is distributed uniformly between the available systems. In this case a database is maintained in which is noted what films are on which system and can thus be processed.

Technical procedure:
a. Determination of the parameters of the pre-encoded main film: the specifications of the pre-encoded main film are retrieved: Codec, pixel resolution, pixel aspect ratio, data rate. The parameter (command) used to pre-encode the long main film is reconstructed from this information.
b. The short trailer is prepared: for this, individual images are first produced with the dimensions of the main film (determined in Point 1) and the personal particulars of the customer are inserted as a title in these images.
c. The short trailer is created: the individual images with personalised title are encoded with exactly the same parameters, so that the trailer displays exactly the same specifications as the pre-encoded main film.
d. The short trailer is inserted into the long main film. For this, only the headers of the newly personalised video file are created anew. The video data are gathered from the already encoded existing file.

Output:

The new header and the video data are transferred to the web server existing on the injecting system tor downloading to the customer. This procedure avoids that one has to newly encode the main film. The new file does not have to be written anew on the hard disk of the injecting system. The newly personalised film file is transferred directly to the customer via the web server and saved there. As a result, the main film maintained on the injecting system does not have to be modified at all. The short trailer can be inserted into the pre-encoded main film during the download.

Effect:

The download of a personalised film file begins at the customer's, without him having to wait for long, already a few seconds after the download link is clicked. When he reads the title with his name, it is immediately clear lo him that the present file is a copy for his own personal use. Anyone who can read can, without any problem, understand to whom the film file belongs. It is indeed technically possible to remove this title again. However, we assume that in practice the customer will be very careful, since he realizes that the file has been personalised and modified for him. It is never possible to say with absolute certainty whether or not further identification features have been hidden in the film in addition to the title.

### 2.4 Billing/Reporting

Input:

The licensor can retrieve an updated report in real time at any time.

Technical procedure:

Information on the revenues due to the licensor from the sale (licence fee) is filed in the database. The revenue can vary depending on the (language) version of the film and the territory in which the customer is located. The licence fee calculated at the moment of sale is credited directly to the licensor's user account.

Output:

The following is displayed to the licensor, broken down according to film version and territory:
Number of trailer proposals to the user
Number of visits to the film's homepage (“more”)
Number of sales (including precise selling time “Timestamp”)
Current settlements of account

Effect:

The licensor can use the system as if it were his own system. He has full control over all contents and has his money directly in his account.

### 3. Address System

All the pages are accessible via URLs that are logically deducible and easy to remember. The tags mentioned in 2.1 B are contained in the URL:

A preview can be accessed at:
http://systemname.topleveldomain/preview+filmtitle
http://cinexe.corn/preview+external

A film homepage can be accessed at:
http://systemname.topleveldomain/filmtitle
http://cinexe.com/external

A person can be accessed at:
http://systemname.topleveldomain/given-name_family-name
http://cinexe.com/Thomas_Joerg

These URLs can also contain restricting keywords:
http://several_keywords.systemname.topleveldomain/preview+filmtitle
http://several_keywords.systemname.topleveldomain/filmtitle
http://several_keywords.systemname.topleveldomain/given-name_family-name

### Examples

http://berlin_action.cinexe.com/preview+foreignl
http://berlin_action.cinexe.com/foreign
http://berlin_action.cinexe.com/Thomas_Joerg
   This simple addressing method makes the system compatible with all web-based internet services. Films can be linked with blogs, social networks, other websites and many others. No closed system is established. The World Wide Web is understood as a system in itself. The present system integrates seamlessly into the www.

1. Media selection and distribution system offering a large number of visual auditory and/or audiovisual media of a number of different exploitation right proprietors or their representatives for selection and purchase by a participant/viewer via media information, comprising (a) a playful and/or (b) systematic access,
wherein a central database, a live encoding system, a raw memory, a media memory, a content-delivery system, a payment system and a billing and reporting system are provided and wherein a film is personalised by the following process steps:
encoding of a main film including metadata,
provision of a pre-encoded main film,
determining parameters of the pre-encoded main film,
preparing trailers by providing individual images having specific dimensions of the main film,
inserting, as clearly visible title, personal particulars of a customer and an electronic signature of a publisher into the individual images,
encoding of the personalised and signed individual images as film with parameters, wherein the parameters are exactly the same parameters as those of the main film, and
inserting trailers into the main film, and
transmission of the individual film to the customer.

2. The system of claim 1,
wherein
in addition to the process steps for personalising the film, the system also contains functions for (i) selection, (ii) payment and (iii) prompt reporting including (iv) billing.

3. A method for providing media comprising the system of claim 1, wherein:
the medium is delivered on basis of an existing licence or cooperation agreement between the proprietor of the exploitation rights or his representative and a system operator,
the medium is filed in the raw memory,
media excerpts are selected and both excerpt and the entire medium are encoded in the encoding system as internet-compatible files and filed in the media memory,
metadata, for example title, contents, summaries, cast and crew lists, preferably including vitae, technical data, awards and contact data are updated into the central database and a consumer price is fixed, wherein the consumer price is determined based on statistical data,
in accordance with (a) three functions are offered when presenting the medium excerpt on a computer screen:
a “next medium”, which triggers the next media excerpt,
“more” which visualises the metadata including the consumer price, and/or
“reserve”, which adds the medium to a wish list and
wherein activation of the three functions is analysed and wherein prompt triggering of the “next medium” function saves the medium as an uninteresting medium, and excerpts that are essentially viewed completely and purchased are saved as interesting, wherein a group of several viewers and/or several purchasers helps a medium to obtain better positioning in a trailer show and wherein the functions “next medium” and “reserve” can be selected any number of times,
the viewer transmits an intention to purchase, and
the central database transmits the already communicated consumer price to the payment system.

4. A method for providing media comprising the system of claim 1, wherein:
in accordance with (b) an overview of the media offered by the proprietors of the exploitation rights or their representatives is transmitted to a computer screen of a viewer, wherein the selection of the media appears on the screen associated with keywords,
the keywords are activated/clicked, wherein media, which are not allocated to said keywords, are deleted from the selection, wherein the viewer can activate/click several keywords, which results in the number of media offered being continuously reduced and wherein, at the same time the list of keywords is updated with each click/activation in such a way that only those keywords appear on the computer screen that can be allocated to the media in a reduced number.

5. System, preferably in accordance with claim 1, that offers a large number of visual, auditory and/or audiovisual media, in particular films, TV broadcasts, series, books, pieces of music, audio plays, audio books, virtual exhibitions or games of a number of different proprietors of exploitation rights or their representatives for selection and purchase and/or rent by a participant/viewer via media information comprising (a) a playful and/or (b) systematic access,
wherein
a raw memory, an encoding system, a database, a media memory, a content delivery system, a payment system and a live encoding system with title generator are provided, wherein
the medium is delivered based on an existing licence or cooperation arrangement between the proprietor of the exploitation rights or his representative and the system operator,
the medium is filed in the raw memory in digital quality and wherein analog media are digitised if appropriate,
a medium excerpt is selected and both the excerpt and the entire medium are encoded in the encoding system as internet-compatible files and kept available in the media memory,
metadata, for example title, contents, summaries, cast and crew lists, production and distribution firms, festivals, promoters and financiers etc., preferably including vitae, technical data, awards and contact data are updated into the central database and a consumer price is fixed,
an address is created, wherein the hyper text transfer protocol (http) address limiting_keywords.systemame.topleveldomain/ leads to display of an optimised preview program, and wherein with address limiting_keywords.systemame.topleveldomain/preview+media-title a channel with the selected medium can be started,
and wherein with address limiting_keywords.systemame.topleveldomain/ media-title the metadata including the consumer price are visualised,
according to (a) presentation of the medium excerpt on the computer screen, wherein three functions are offered:
“next medium”, which triggers the next media excerpt,
“more”, which visualises the metadata including the consumer price, and/or
“reserve”, which adds the medium to a wish list,
wherein activation of the three functions is analysed and wherein prompt triggering of the “next medium” function saves the medium as an uninteresting medium, and excerpts that are essentially viewed completely and purchased are saved as interesting, wherein a group of several purchases helps a medium to obtain better positioning in a trailer show and wherein the functions “next medium” and “reserve” can be selected any number of times,
the viewer transmits an intention to purchase one or more media,
the central database transmits an already communicated consumer price to the payment system,
payment information, a name and address of the viewer are transmitted to the payment system, which verifies payment and reports the verification to the distribution system,
the name and/or email address of the viewer is transmitted to the encoding system,
the complete medium is retrieved from the media memory to the encoding system, wherein the medium is personalised by the said name and/or email address, with the personalising taking place in a manner legible for humans, in particular by displaying the purchaser's name and email address as a title in the image, and the personalised medium is delivered via the content-delivery network and the resulting transmission costs are reported to the database, or
according to (b) an overview of the media offered by the proprietors of the exploitation rights or their representatives is transmitted to a viewer's computer screen, wherein a selection of media appears on the screen associated with keywords,
wherein, when the keywords are activated/clicked, media, which are not allocated to said keywords, are deleted from the selection, wherein the viewer can activate/click several keywords, which results in the number of media offered being continuously reduced and wherein, at the same time, the list of keywords is updated with each click/activation in such a way that only those keywords appear on the computer screen that can be allocated to the media in a reduced number, and
if appropriate, repetition of this operation until the number of media offered is reduced to one medium.

6. The system of claim 1, wherein the media are films, books, pieces of music, audio plays, audio books, virtual exhibitions or games.

7. The system of claim 1, wherein the parameters of the pre-encoded main film are size, dimensions, format and/or data rate.

8. A method for offering a large number of visual auditory and/or audiovisual media comprising
encoding and condensing on a content-delivery-system accessible by one or more processors a main film including metadata via a live encoding system so that a pre-encoded main film including metadata is provided,
computer-aided determination of parameters of the pre-encoded main film including size, dimensions, format and data rate,
wherein a computer-aided or manual extracted excerpt of the pre-encoded main film with the dimensions of the main film, or an available trailer of the main film is provided,
displaying the excerpt or the trailer to a potential customer on a projection screen, preferably a computer screen,
computer-aided insertion, as a clearly visible title, of personal particulars of the customer and an electronic signature of the publisher of the pre-encoded main film into the individual images of the excerpt or the trailer to produce personalized and signed image(s),
computer-aided encoding of the personalised and signed individual image(s) with parameters, wherein the parameters are exactly the same parameters as those of the pre-encoded main film, so that the images display specifications which are exactly those of the pre-encoded main film,
computer-aided insertion of the personalised and signed individual images into the pre-encoded main film, by combining video data of the personalised and signed individual image(s) and the pre-encoded main film, and
remote data transmission of the film to the customer, wherein the customer accesses the film via a projection screen, preferably a computer screen, wherein the media are provided by different exploitation right proprietors or their representatives.

9. Media selection and distribution system offering a large number of visual auditory and/or audiovisual media of a number of different exploitation right proprietors or their representatives, comprising:
one or more processor readable media that are accessible by one or more processors;
one or more communication devices operatively coupled to the one or more processors;
at least one database stored on the one or more processor readable media, the at least one database comprising:
a pre-encoded main film including metadata,
parameters of the pre-encoded main film including size, dimensions, format and data rate,
trailers in form of individual images with specific dimensions of the main film,
wherein the one or more processors are programmed and configured to:
insert personal particulars of a customer and a electronic signature of the publisher into the individual images created as clearly visible title to create personalized and signed individual images,
encode the personalised and signed individual images as film with exactly the same parameters as the main film,
insert the trailers into the main film and
transmit the individual film to the customer, wherein the customer accesses the film via (a) a playful interface or (b) a systematic interface and wherein the media are provided by different exploitation right proprietors or their representatives.

10. The method of claim 8, wherein the computer screen provides (a) a playful interface or (b) a systematic interface.

11. The method of claim 10, wherein in accordance with (a) three functions are offered when presenting the medium excerpt on a computer screen:
“next medium”, which triggers the next media excerpt,
“more” which visualises the metadata including the consumer price, and/or
“reserve”, which adds the medium to a wish list and
wherein activation of the three functions is analysed and wherein prompt triggering of the “next medium” function saves the medium as an uninteresting medium, and excerpts that are essentially viewed completely and purchased are saved as interesting, wherein a group of several viewers and/or several purchasers helps a medium to obtain better positioning in a trailer show and wherein the functions “next medium” and “reserve” can be selected any number of times.

12. The method of claim 10, wherein according to (b) an overview of the media offered by the proprietors of the exploitation rights or their representatives is transmitted to a viewer's computer screen, wherein a selection of media appears on the screen associated with keywords, and wherein, when the keywords are activated/clicked, media, which are not allocated to said keywords, are deleted from the selection and wherein the viewer can activate/click several keywords, which results in the number of media offered being continuously reduced and wherein, at the same time, the list of keywords is updated with each click/activation in such a way that only those keywords appear on the computer screen that can be allocated to the media in a reduced number.

13. A method for providing media comprising the system of claim 1.

14. A method for providing media comprising the system of claim 5.
